(19) United States
(12) Patent Application Publication
(10) Pub. No.: US 2018/0229415 A1
(43) Pub. Date: Aug. 16, 2018

(54) SYSTEM AND METHOD FOR MANUFACTURING FLIGHTLESS, MONOLITHIC BELT

(71) Applicant: Habasit AG, Reinach (CH)

(72) Inventor: Zouhir ADLANI, New Britain, CT (US)

(21) Appl. No.: 15/747,259

(22) PCT Filed: Jul. 27, 2016
(86) PCT No.: PCT/EP2016/067900

§ 371 Date: Jan. 24, 2018

Related U.S. Application Data
(60) Provisional application No. 62/199,214, filed on Jul. 30, 2015.

(51) Int. Cl. B29C 47/00; B29D 29/08; B65G 15/30

(52) U.S. Cl. CPC B29C 47/0064; B29C 47/0061; B29L 2031/7094; B65G 15/30; B29D 29/08

(57) ABSTRACT

A method for making a reinforced monolithic belt (85) comprises: —extruding belt material (80) onto a rotating molding wheel (12); —passing the belt material (80) into a mold cavity (30) formed by an endless band (20) engaging on a peripheral portion of the molding wheel (12); and —laying a coated reinforcing cord (45) onto the molding wheel (12) before the mold cavity (30). This method allows producing a reinforced monolithic belt with no flights.

### FIELD OF THE INVENTION

The present invention relates to monolithic belting having coated reinforcing cords.

### BACKGROUND OF THE INVENTION

Reinforced monolithic belts have been manufactured in one of two ways. In the first method, the belt material (generally a thermoplastic resin) is extruded onto a molding wheel 90 having “flights” 92 or “noses” (see FIG. 1A). A reinforcing cord is laid into the material and is maintained a precise distance from the bottom side of the formed belt by the noses. However, the resulting belt formed in this process will have impressions 94 formed by the flights (see FIG. 1B). Such impressions create a space where food can become trapped and is difficult to wash out. Additionally, the reinforcing cord, which may be partially exposed in the impressions, is more susceptible to corrosion and/or wear due to the exposure.

The other method used to manufacture such belts was designed to make flightless belts. In this method, the extruded resin is applied in two layers. A first layer of resin is applied to a molding wheel and a reinforcing cord is laid onto the first layer. Then, a second layer of resin is deposited onto the first, thereby embedding the cord between the layers. While this method is successfully used to create a flightless belt, belts made in this fashion have been found to suffer from premature failure, such as delamination failures, where the layers of the belt separate.

There is a need for a manufacturing method to create a belt which resists contamination, is easy to clean, and is structurally sound. Such a method of manufacture should also allow precise placement of the reinforcing cord, and create belts wherein the cord is not susceptible to corrosion through exposure.

### BRIEF SUMMARY OF THE INVENTION

The present invention meets the above-described need by providing a method for making a reinforced monolithic belt according to independent claim 1 and a system (apparatus) for making a reinforced monolithic belt according to independent claim 7. Preferred embodiments will emerge from the dependent claims.

The present invention provides a system and method of making no flight timing belt or flat belt in a single pass using elastomer, such as thermoplastic urethane or, generally, thermoplastic elastomer, and coated reinforcing cord. The present techniques reduce manufacturing times and costs. Producing belts with no flights allow reduced potential for contamination and corrosion. The present techniques also provide one-step manufacturing process for accurate positioning of reinforcing cord to provide proper pitch line differential (PLD) for a belt with good pulley engagement.

### DESCRIPTION OF THE DRAWINGS

For a fuller understanding of the nature and objects of the invention, reference should be made to the following detailed description taken in conjunction with the accompanying drawings, in which:

FIG. 1A is a diagram of a portion of a molding wheel having noses (flights);

FIG. 1B is a cross-section view of a portion of a belt made using the molding wheel of FIG. 1A;

FIG. 2 is a diagram of a system according to an embodiment of the present invention;

FIG. 3A is a diagram of a portion of a molding wheel without noses;

FIG. 3B is a cross-sectional diagram of a belt made using techniques according to the present invention;

FIG. 4A shows an exemplary coated reinforcing cord used in embodiments of the present invention as viewed from a longitudinal end;

FIG. 4B shows a longitudinal-end view of a belt made with a coated reinforcing cord according to the present invention; and

FIG. 5 is a chart showing a method according to another embodiment of the present invention.

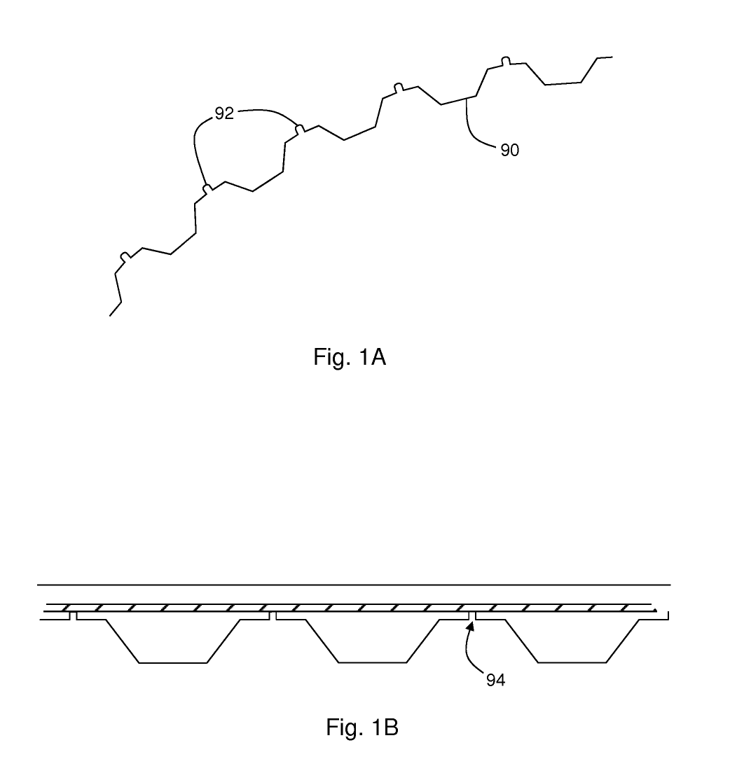

### DETAILED DESCRIPTION OF THE INVENTION

The present invention provides a system and method for manufacturing open ended belts made of an elastomeric matrix in which one or more tension members (reinforcing cords) are embedded into the belt material in a longitudinal direction. Such belts can be toothed belts, flat belts, multi-V-ribbed belts, conveyor belts, or similar belt products. The invention is particularly useful for making toothed belts which require precise control of tooth spacing or pitch, as well as accurate cord positioning, resulting in precise PLD.

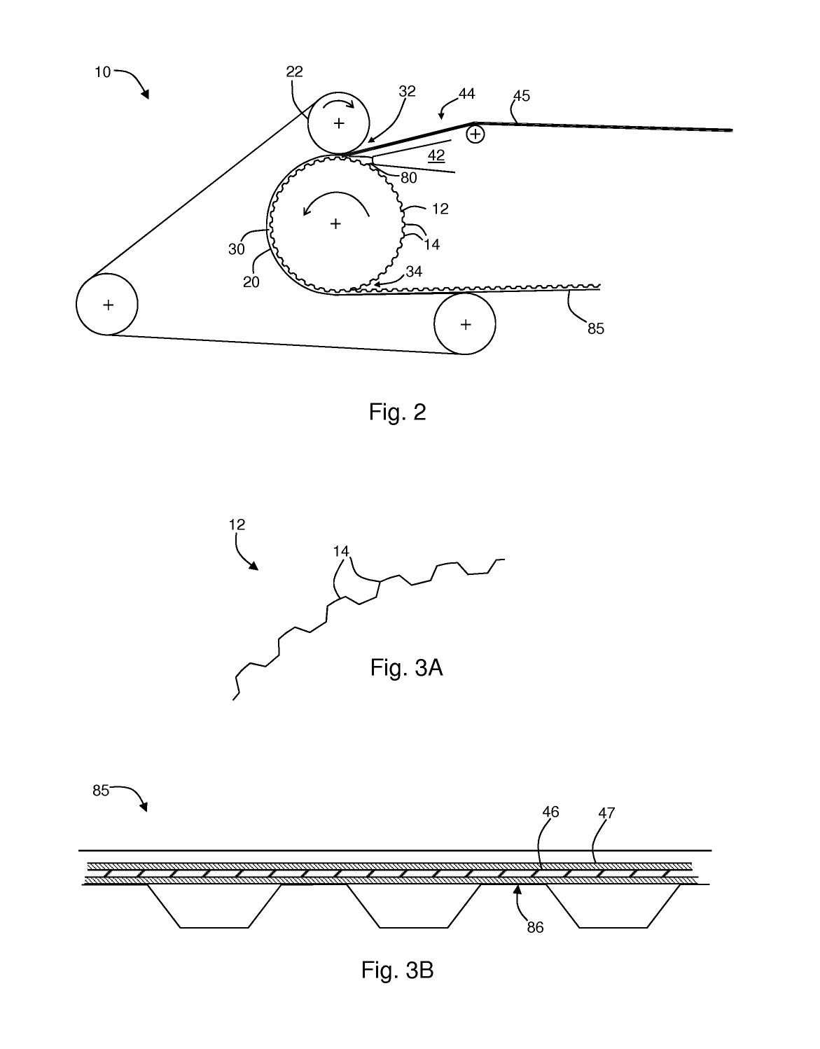

With reference to FIG. 2, in an aspect of the present invention, a system 10 for making a reinforced monolithic belt is provided. The term “monolithic” is used herein to refer to a belt made from a continuous layer of a thermoplastic material. Such belts are commonly used in conveyance operations in the food industry, but it will be recognized such belts are used in other industries as well.

The system 10 comprises a molding wheel 12, which is configured to rotate. In some embodiments, the molding wheel 12 has a series of ridges 14 for forming corresponding structures (e.g., teeth) in the resulting belt 85 (see, e.g., FIG. 3A). The molding wheel 12 is flightless—i.e., the wheel 12 does not include structures to hold a reinforcing cord at a distance from the bottom of the belt. The system 10 comprises an endless band 20 configured to cooperate with a peripheral portion of the molding wheel 12 to form a mold cavity 30. The mold cavity 30 includes an entrance 32 where belt material 80 is introduced into the mold cavity 30. The entrance 32 may be located where the endless band 20 rounds a pulley 22 which positions the band 20 adjacent to the molding wheel 12. An exit 34 is formed where the band 20 is moved away from the periphery of the molding wheel 12 (i.e., where a formed belt 85 emerges).

A die head 42 is configured to deposit and spread extruded belt material 80 onto the molding wheel 12. The belt material 80 is the material that makes up the bulk of the belt 85. The material may be an elastomer, for example, thermoplastic urethane (TPU), thermoplastic elastomer (TPE), or other thermoplastics or blends thereof. The invention can also be adapted for use with castable or thermoset resins or for a vulcanized rubber matrix. For example, a coated cord can be passed into the mold and a thermoset material can be deposited to form a timing belt from a thermoset resin. The die head 42 is located such that the extruded belt material 80 is deposited ahead of the entrance 32 such that, as the molding wheel 12 rotates, the extruded material 80 is moved through the entrance 32 into the mold cavity 30. As will be apparent to one having skill in the art in light of the disclosure, the material is deposited onto the molding wheel 12 at an elevated temperature and cools while in the mold cavity 30 such that the material will hold its form when exiting the mold cavity 30.

The system 10 comprises a feeder 44 which is configured to pass a coated reinforcing cord 45 onto the molding wheel 12 ahead of the entrance 32 to the mold cavity 30. The reinforcing cord 45 may be coated with a thermoplastic or other material compatible with the belt material 80. By compatible, it is intended that the coating of the coated cord 45 will bond with the belt material 80 so as to maintain integrity of the bond after the belt 85 is formed. In some embodiments, the coating of the cord is the same material as the belt material 80. For example, in an exemplary embodiment where the belt material is TPE, the reinforcing cord may be coated with TPE.

The tension members (reinforcing cords 45) typically comprise coated cords, yarns, fibers, or filaments of steel, but could alternatively or additionally comprise stainless steel, glass, aramid, carbon, polyester, polyamide, basalt, or other suitable materials or hybrids thereof. A yarn may be a bundle of fibers, filaments, or wires and may be twisted or cabled. A cord may be a twisted, braided, or cabled yarn or bundle of yarns. The terms wire and cable are often used in connection with metal cords or metal tension members. The terms “cord” and “tensile member” are used herein to refer to all types of tension members. Fabric layers or other non-typical types of tensile reinforcement may also be used as the tensile members of the invention.

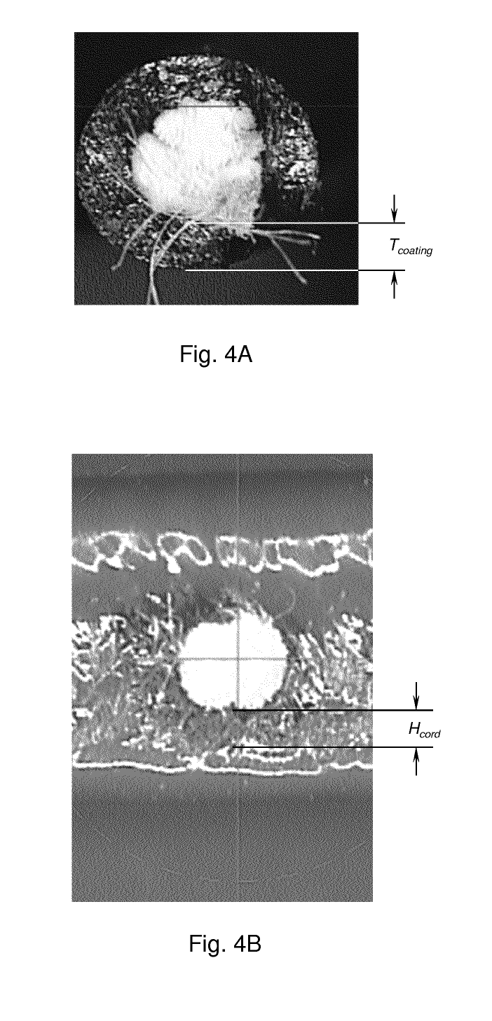

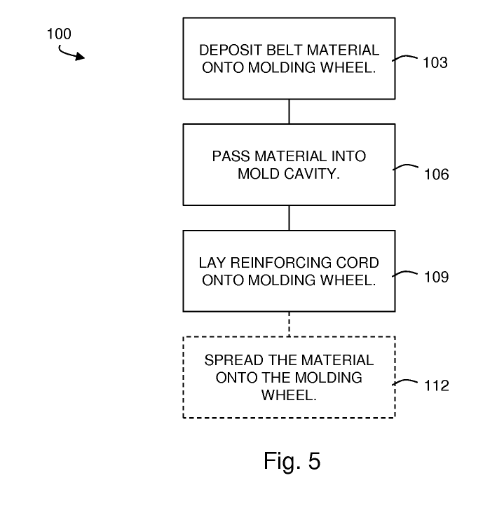

By using a coated reinforcing cord 45, the cord 46 is held off of the molding wheel 12 by the coating, without the use of flights. As such, the distance, H_{cord}, between the bottom (land region) 86 of the belt 85 is substantially the same as the thickness, T_{coating}, of the coating 47 of the coated reinforcing cord 45 (see, e.g., FIGS. 3B, 4A, and 4B). The coating thickness may be selected based upon the belt profile. For example, timing belts have known profiles such as, for example, T, AT, HTD, STD, RPP series profiles, as well as imperial pitches like H, XH, etc. For each profile, a particular pitch line differential (PLD) is needed to provide proper engagement of the belt and the coating thickness is selected based upon the profile. PLD is a measure of the thickness of the belt under the cord line and is defined as the distance from the belt surface in the land 86 region to the cord center line. In this way, the PLD is kept intact while manufacturing the belt in a single pass around the molding wheel. For example, a T-profile belt may have a PLD=1 mm, a cord diameter=0.63 mm, and a wall thickness=PLD−(cord diameter/2)=1 mm−(0.63 mm/2)=0.685 mm.

In another aspect of the present invention, a method 100 for making a reinforced monolithic belt is provided. The method 100 comprises depositing 103 extruded belt material onto a rotating molding wheel. In some embodiments, the material is passed 112 under a spreader to further spread the material onto the molding wheel. The material is passed 106 into a mold cavity formed by an endless band cooperating with a peripheral portion of the molding wheel. A coated reinforcing cord is laid 109 onto the molding wheel ahead of the mold cavity. In some embodiments, the reinforcing cord is laid 109 onto the molding wheel ahead of where the belt material is deposited 103 onto the molding wheel. As such, the belt material is deposited 103 onto the reinforcing cords. In other embodiments, the reinforcing cord is laid 109 onto the molding wheel behind where the belt material is deposited 103 molding wheel such that the cord is laid into the extruded material.

The belt material, the cord coating material, and the cord may be of any type, such as those described above.

Through the use of the presently disclosed techniques, a belt is produced where cord fraying can be reduced by elimination of a flight area, thereby providing a longer belt lifespan, reduced potential for contamination, and reduced potential for corrosion, for example, in the case of steel cord.

Although the present invention has been described with respect to one or more particular embodiments, it will be understood that other embodiments of the present invention may be made without departing from the spirit and scope of the present invention.

1. A method for making a reinforced monolithic belt, comprising:
extruding belt material onto a rotating flightless molding wheel;
passing the belt material into a mold cavity formed by an endless band engaging on a peripheral portion of the molding wheel; and
laying a reinforcing cord coated with TPE onto the molding wheel before the mold cavity.

2. The method according to claim 1, comprising:
passing the belt material under a spreader, by rotating the molding wheel, to spread the belt material onto the molding wheel before passing the belt material into the mold cavity.

3. The method according to claim 1, wherein the coated reinforcing cord has a coating compatible with the belt material such that the coating and the belt material form a bond.

4. The method according to claim 1, wherein the coated reinforcing cord has a coating which is the same material as the belt material.

5. The method according to claim 1, wherein the coated reinforcing cord is laid onto the molding wheel before the belt material is extruded onto the molding wheel.

6. The method according to claim 1, wherein the coated reinforcing cord is laid onto the molding wheel after the belt material is extruded onto the molding wheel.

7. A system for making a reinforced monolithic belt, comprising:
a flightless molding wheel, configured to rotate;
an endless band configured to cooperate with a peripheral portion of the molding wheel to form a mold cavity, wherein the mold cavity includes an entrance for introducing belt material into the mold cavity and an exit from which a formed belt is obtained;
a die head configured to extrude belt material onto the molding wheel ahead of the entrance of the mold cavity; and
a feeder passing a reinforcing cord coated with TPE onto the molding wheel ahead of the entrance to the mold cavity.

8. The method according to claim 2, wherein the coated reinforcing cord has a coating compatible with the belt material such that the coating and the belt material form a bond.

9. The method according to claim 2, wherein the coated reinforcing cord has a coating which is the same material as the belt material.

10. The method according to claim 3, wherein the coated reinforcing cord has a coating which is the same material as the belt material.

11. The method according to claim 2, wherein the coated reinforcing cord is laid onto the molding wheel before the belt material is extruded onto the molding wheel.

12. The method according to claim 3, wherein the coated reinforcing cord is laid onto the molding wheel before the belt material is extruded onto the molding wheel.

13. The method according to claim 4, wherein the coated reinforcing cord is laid onto the molding wheel before the belt material is extruded onto the molding wheel.

14. The method according to claim 2, wherein the coated reinforcing cord is laid onto the molding wheel after the belt material is extruded onto the molding wheel.

15. The method according to claim 3, wherein the coated reinforcing cord is laid onto the molding wheel after the belt material is extruded onto the molding wheel.

16. The method according to claim 4, wherein the coated reinforcing cord is laid onto the molding wheel after the belt material is extruded onto the molding wheel.
